(19) United States
(12) Patent Application Publication
(10) Pub. No.: US 2003/0171130 A1
(43) Pub. Date: Sep. 11, 2003

(54) Method and communication system for transmitting information

(75) Inventor: Miodrag Sajatovic, Vienna (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Frequentis Nachrichtentechnik Gesellschaft m.b.H.

(21) Appl. No.: 10/308,336

(22) Filed: Dec. 2, 2002

(30) Foreign Application Priority Data
Dec. 3, 2001 (AT) A 1892/2001

(51) Int. Cl. H04B 1/034; H04B 1/06

(52) U.S. Cl. 455/518; 455/98; 455/345

(57) ABSTRACT

Information is transmitted between a transmitter, on board of an aircraft for example, having a PTT-key and a receiver, at an air traffic ground control station for example, by generating an AF signal at the transmitter with speech data from a speech transducer. The AF signal is converted into an RF signal and the transmission of the RF signal is initiated by activating the PTT-key. Additional data for transmission from the transmitter to the receiver is combined with speech data by suppressing a predetermined portion of an AF speech spectrum of the AF signal and embedding the additional data in the suppressed portion of the AF speech spectrum. The RF signal is demodulated at the receiver and used.

### BACKGROUND OF THE INVENTION

This invention concerns the transmission of information between a transmitter and a receiver on aircraft and ground stations in which speech data from a speech transducer generated as audio frequency (AF) signals are transmitted as radio frequency (RF) signals. Transmission is initiated by activating a Push-to-Talk (PTT) key. The receiver demodulates the incoming RF signal for the subsequent use.

Communication systems of this type are primarily used for transmitting information between aircraft and ground stations. Such communications are for aircraft, including helicopters, independent of their size.

Speech communication between aircraft and ground is used for air traffic control (ATC) and airline operational communications (AOC). Such communication is critical to maintain safety and is implemented in specially protected portions of the aeronautical spectrum (HF, VHF, UHF). Dual side band amplitude modulation (DSB-AM) is universally used for this purpose.

Access to the partitioned simplex R/T (radio telephony) communication channel is based on a “hear before you activate the PTT” procedure: The ground controller and pilot must monitor the radio traffic to determine if the radio channel is available before they are permitted to occupy the channel and speak by activating the PTT-key. Speech communications normally last for several seconds.

### BRIEF SUMMARY OF THE INVENTION

It is a primary object of the invention to enable the transmission of additional data between a transmitter and a receiver, especially between aircraft and ground stations, without in any manner compromising the technical and/or procedural safety features of current communications systems and procedures. One could provide separate transmitters and receivers both at the aircraft and the ground station, but this approach has the disadvantage that it is relatively costly and could undesirably affect other communication services in the heavily used aeronautical frequency range. The present invention provides a system and method for the transmission of information which is of relatively simple construction and assures fast data transmissions. The present invention also makes it possible to retrofit existing systems at reasonable cost.

Generally speaking, the present invention transmits information between a transmitter having a PTT-key and a receiver by generating an AF signal at the transmitter with speech data from a speech transducer. The AF signal is converted into an RF signal and the transmission of the RF signal is initiated by activating the PTT-key. Additional data for transmission from the transmitter to the receiver is combined with speech data by suppressing a predetermined portion of an AF speech spectrum of the AF signal and embedding the additional data in the suppressed portion of the AF speech spectrum. The RF signal is demodulated at the receiver and used.

The speech channel for air-to-ground R/T radio communications operates at an AF band width of 3,000 Hz (300 Hz-3,400 Hz). Within this frequency band, the speech spectrum is neither flat nor time invariable: The speech spectrum changes with time and has two typical peaks and one trough (at about 2 kHz). The most important speech information is concentrated in the vicinity of the spectral peaks, while the portion occupied by the trough has little influence over the quality of the speech transmission.

The present invention provides a particularly simple way for transmitting the additional data within a narrow band of the frequency range of the aeronautical R/T communication channel. The additional data can be of any desired type. For example, such data can be data that is stored at the airplane or the ground station. The data can also be of the type which changes with the progress of the aircraft. The frequency range for the transmission of data is preferably in a suppressed portion of the speech spectrum between about 1.5 to 2.5 kHz, and preferably between 1.8 to 2.3 kHz.

The communication system of the present invention can be used for the general transmission of aeronautical data between the pilot and the ground station, for example an air traffic controller, airline dispatchers or an automatic ground control system. It is also possible to use the transmitted additional data for addressing or remotely controlling individual systems on the aircraft from the ground, or to achieve a targeted takeover of the control from the ground, via individual aircraft communication systems. The communication system of the present invention can thus be part of an automatic onboard system which maintains communication with the ground station in accordance with the invention.

The present invention provides a number of advantages which go beyond the secure and fast transmission of information.

At present it is impossible to identify or authenticate an aircraft with purely technical means of the ATC aircraft radio systems. Current regulations achieve identification at an operational rather a technical level by having the pilot and the controller introduce each other at the beginning of a speech transmission. It is difficult to verify such identifications or to use them for tracking the aircraft (other than “tracking it in the mind of the controller”). It is similarly technically not possible for the pilot to verify or authenticate if and, if so, with which controller he speaks. As a result, “phantom pilots” and “phantom controllers” can access ATC radio channels with relatively simple and primitive equipment. Luckily, such intruders are typically recognized as such. However, this takes place without any system support as a result of the experience of pilots and controllers and their familiarity with the characteristics of ATC communications.

In accordance with the invention the ICAO 24-bit code (for the positive identification of every airplane) is preferably automatically transmitted each time the pilot activates the PTT. In this manner, an onboard system can automatically provide valuable information about the identity of the airplane to controllers and ground control systems, instead of having to rely on speech transmissions from the pilot or other persons on board. Such automatic verification of the speaking party helps reduce the problem presented by “phantom pilots”.

In the other direction, each ATC ground transmitter can include a positive identification code in each message it sends. In this manner, pilots can readily distinguish between a genuine message and one originating from a phantom controller who will not have such a code.

In addition to identifying aircraft and ground transmitters, the present invention can be used for the transmission of any short information in the up-link or down-link direction, i.e. from ground to aircraft or vice versa, provided the information can be formatted into short broadcast messages or “squitters” of a predefined length. Another use for the present invention is for up-link instructions to the pilot concerning flight routes and supervision.

At present such directions are transmitted orally and ground controllers frequently consider them as boring routines. As an alternative, the ground controller can preselect the intended airplane as well as its next R/T frequency prior to the transmission of speech by briefly depressing the PTT-key so that instructions are transmitted in the “in-band data channel” provided by the present invention, which may optionally also include confirmation from the pilot. Such data transmissions can occur simultaneously with or even in place of speech transmissions.

If the connection unit or onboard “in-band system” are coupled with the onboard navigational system, the flight position determined on board can be transmitted to the ground control system as an in-band Automatic Dependent Surveillance (ADS) report each time the PTT is activated. This information can provide additional surveillance information for ground control systems, particularly in the vicinity of airports.

For General Aviation (GA) involving uncontrolled or unmanned landing strips and airports, the present invention permits a pilot to request or initiate specific action by the ground control system. For example, the present invention can be used to automatically activate the Automatic Terminal Information Service (ATIS) transmitter or the runway lights.

Pilots who use AOC speech frequencies often wish to direct the intended speech transmission to one of several AOC ground units, such as maintenance, dispatchers, crew headquarters and the like. Systems currently in use do not permit this, to prevent the interruption of ground units with messages not addressed to them. The present invention makes it possible to address down-link messages to the desired party via the AOC frequency in the form of preconfigured in-band address messages or codes which are inserted as down-link squitters prior to activating the PTT.

### BRIEF DESCRIPTION OF THE DRAWINGS

FIG. 1 schematically illustrates the communication system of the present invention and the principle of the “in-band modem”;

FIG. 2 shows an AF spectrum with the in-band modem signal as well as a modulated information carrier in a suppressed portion of the AF spectrum;

FIG. 3 shows a transmitter of the communication system of the present invention as an in-band subsystem transmitting unit;

FIG. 4 shows a receiver of the communication system of the present invention as an in-band subsystem receiving unit; and

FIG. 5 shows an AF signal transmitted by the communication system of the present invention with an embedded signal which transmits the additional data.

### DETAILED DESCRIPTION OF THE INVENTION

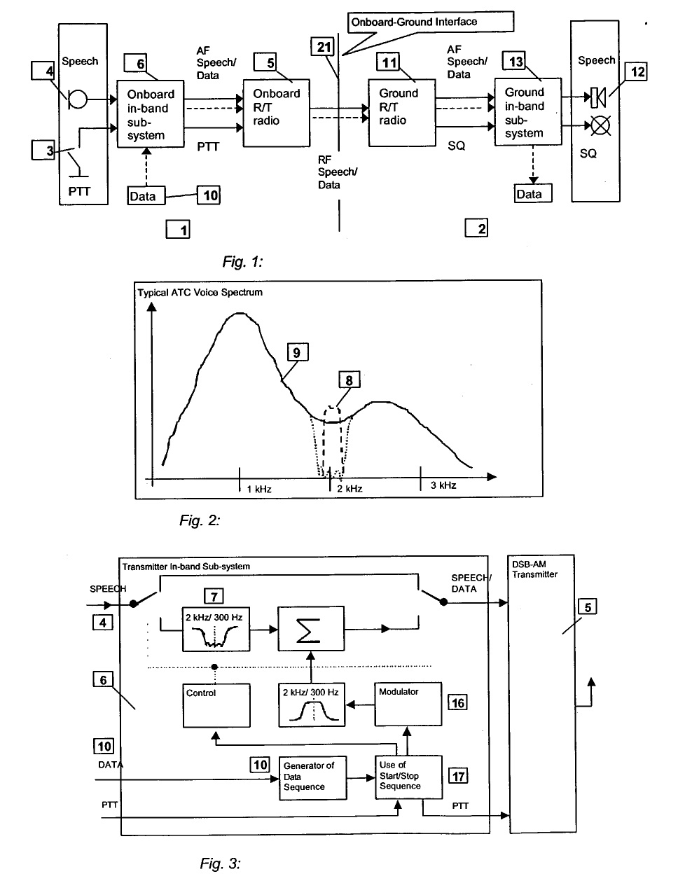

FIG. 1 schematically shows the method by which the present invention transmits information between a transmitter 1 and a receiver 2, as well as the underlying principles. Currently only voice communications are sent between the transmitter and the receiver. Transmitter 1, which can be installed on an airplane or at a ground station, includes a speech transducer 4, such as a microphone. When a PTT-key 3 is depressed, a transmitting unit 5 transmits an RF signal which carries the required speech data. In accordance with the present invention, a connection unit 6, also referred to as an “in-band subsystem”, is interposed between speech transducer 4 and transmitting unit 5. The connection unit 6 includes a frequency barrier 7 which removes a portion 8 of the AF speech spectrum 9 at the moment PTT-key 3 is activated, or within a predetermined time interval thereof. The connection unit 6 has a data storage or memory, or a data generator 10, for providing the additional data that is to be transmitted. This additional data is embedded in the previously removed portion 8 of the AF speech spectrum 9 for transmission of the AF speech spectrum, including the additional data, by transmitting unit 5. The band width of AF speech spectrum 9 that is reserved for the additional data is about 300 Hz. It is preferable to select the frequency center for frequency portion 8 at about 2 kHz because this frequency range contributes the least to speech clarity. Of course, the frequency portion 8 that is to be removed can lie in any other desired part of the audio spectrum; for example it can be above 2.5 kHz.

FIG. 2 shows a typical ATC voice spectrum 9 from which a portion 8 at about 2 kHz has been removed. This portion 8 of the voice spectrum was used for a signal. The “in-band subsystem” performs its function in a manner analogous to modems. As is shown in FIG. 5, an R/T transmission or an RF signal transmission of speech data have the additional data to be transmitted embedded as is shown in the left portion of FIG. 5.

A transmission from an airplane to a ground station, as well as from a ground station to the airplane, employs the present invention in the same manner. FIG. 1 illustrates that at the transmitter the present invention can be constructed by simply placing a connection unit between the sound transducer, e.g. a microphone, and the transmitting unit. At the receiver, a separator 13 is placed between the receiving unit 11 and speech transducer or speaker 12, as is also shown in FIG. 1.

FIG. 1 further schematically illustrates a transmission interface 21 between transmitter 1 and receiver 2.

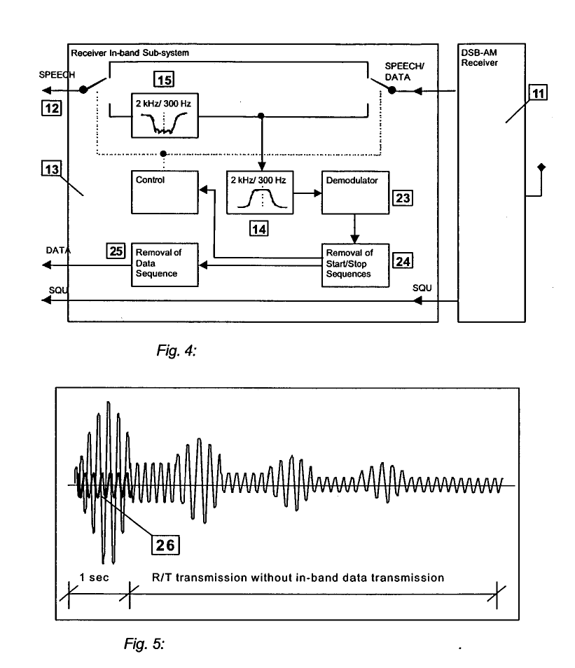

FIGS. 3 and 4 demonstrate the implementation of the present invention. Connection unit 6 responds when the pilot activates PTT-key 3 and uses the resulting signal to initiate the release of additional data and forward it to transmitter 5. The connection unit 6 has a frequency barrier 7 that removes or suppresses a portion of the AF (pilot) speech spectrum 9 in the vicinity of 2 kHz. This occurs irrespective of whether or not the pilot speaks. At the same time, the preferably stored additional data is forwarded to connection unit 6. Alternatively, the additional data can be obtained from a suitable data generator. The additional data is modulated onto an appropriate carrier frequency and embedded in the “reserved” portion 8 of the AF spectrum in the manner of a modem signal for forwarding it with the speech data to transmitting unit 5.

The additional data that is to be transmitted can be stored in a data storage or memory 10 or obtained from a data generator 10 at the appropriate point in time. A unit 17 can be used for inserting start and stop codes or sequences in the additional data and/or provide the control, signaling and/or synchronization data needed for the transmission of the additional data. A data modulator 16 modulates the additional data onto a carrier frequency, and the resulting signal is embedded in the AF spectrum.

The combined AF signal with the embedded additional data is DSB-AM modulated in transmitter 5 and is then transmitted. The resulting DSB-AM RF signal is received by receiver 11, which processes the DSB-AM signal. At the same time, receiving unit 11 can provide an SQ (squelch break) signal, and the demodulated AF signal can be forwarded with the “in-band” modem signal to separator 13.

The separator 13 at receiver 2 removes the modem signal from the combined AF signal with an appropriately configured band pass filter 14. The corresponding demodulation takes place in a data demodulator 23. Start and stop codes or sequences are removed at 24 and the additional data of interest is extracted at 25 and then forwarded to a data user coupled to separator 13.

At the same time, the carrier signal for the additional data is preferably removed from the AF signal with a frequency barrier 15 so that this portion of the signal is no longer audible. The combined AF signal, which contains speech data and additional data, is forwarded to speaker 12 without portion 8 of the speech spectrum.

To reliably correlate the transmission of the additional data with the release of the RF signal, and to conform with regulations governing aircraft data traffic, the release of the additional data to the RF signal is tied to the procedure for initiating aeronautical speech communications; that is, it is reliably initiated by the activation of PTT-key 3.

The present invention combines the transmission of the additional data with the transmission of speech data. This means that the additional data can only be sent with or following the activation of the PTT-key 3. In this context, it is particularly advantageous to maintain PTT-key 3 activated independently of its actual touch activation for a predetermined, adjustable minimum time interval. This assures that the data block reserved for the transmission of additional data is in fact transmitted. It is preferable to limit the transmission of the contemplated additional data to data blocks and/or to provide an adjustable time span for the transmission of the additional data which is sufficient for transmitting brief data squitters. The minimum time duration for maintaining the RF transmission following the activation of the PTT-key 3 preferably exceeds the maximum duration of the data squitter. If necessary, the connection unit 6 is constructed so that it maintains the PTT signal for an adjustable, predetermined time duration to prevent a deactivation of transmitting unit 5 in direct response to the release of PTT-key 3 before the transmission of the additional data has been completed. It is preferred that the time duration for such data squitters is between 0.5 to 1.5 seconds and preferably that it is about 1 second. At the end of the time duration reserved for the transmission of a data squitter, the connection unit 6 is deactivated and thereafter only speech data is transmitted, as is common in radio transmissions between airplanes and ground stations and vice versa.

As an advantageous alternative, the suppression of a portion of the frequency spectrum for a predetermined time interval can occur automatically or in response to activating the PTT-key.

For setting the duration of the data squitter and/or the minimum duration of the RF signal that is to be sent following the activation of the PTT-key and/or the duration between the activation of the PTT-key and the release of the data, appropriately adjustable timers can be provided.

The timers are preferably in unit 17 which controls the transmission of the additional data in dependency on the PTT signal.

What is claimed is:

1. A method for transmitting information between a transmitter having a PTT-key and a receiver comprising generating an AF signal at the transmitter with speech data from a speech transducer, transmitting the speech data as an RF signal and initiating the transmission by activating the PTT-key, providing additional data for transmission from the transmitter to the receiver and combining the additional data with speech data by suppressing a predetermined portion of an AF speech spectrum of the AF signal, embedding the additional data in the suppressed portion of the AF speech spectrum for the transmission thereof with the speech data, demodulating the received RF signal at the receiver, and using the AF signal received by the receiver.

2. A method according to claim 1 including placing one of the transmitter and the receiver in an airplane and the other one of the transmitter and the receiver at a ground station.

3. A method according to claim 1 including DSB-AM modulating the AF signal into the RF signal.

4. A method according to claim 1 wherein suppressing comprises removing the portion of the AF speech spectrum with a frequency barrier.

5. A method according to claim 1 wherein suppressing the portion of the speech spectrum occurs over a predetermined time interval.

6. A method according to claim 5 wherein the predetermined time interval is initiated in response to activating the PTT-key.

7. A method according to claim 1 including inserting the additional data in the suppressed portion of the AF speech spectrum after activating the PTT-key.

8. A method according to claim 1 including providing a band pass filter at the receiver and removing the portion of the AF speech spectrum containing the additional data from the AF speech spectrum with the band pass filter.

9. A method according to claim 8 including removing a carrier signal associated with the additional data from the transmitted AF signal.

10. A method according to claim 1 wherein the transmission of the RF signal occurs immediately following activating the PTT-key.

11. A method according to claim 1 wherein the transmission of the RF signal occurs after an adjustable time interval following activating the PTT-key.

12. A method according to claim 1 including limiting a time interval for the transmission of the additional data to an adjustable time interval.

13. A method according to claim 1 including selecting a predetermined time interval for transmitting the additional data with the RF signal, and wherein activating the PTT-key comprises activating the PTT-key for a time period which exceeds the predetermined time interval.

14. A method according to claim 13 including continuing transmitting the RF signal after the predetermined time interval and while the PTT-key is still activated.

15. A method according to claim 1 including adding navigational directions to the additional data for transmission to a pilot of,an airplane.

16. A method according to claim 1 including generating the additional data with a navigational system of an airplane, adding to the additional data information concerning the position of the airplane, and one of activating an operational system at the ground station with the transmitted additional data and activating the navigational system of the airplane with the operational system of the ground station.

17. A method according to claim 1 including adding to the additional data prior to its transmission at least one of a start code, a stop code, synchronization data and control data.

18. A method according to claim 1 wherein transmitting comprises transmitting information between an airplane and a ground station.

19. Apparatus for transmitting information between a transmitter and a receiver comprising a provider of an AF signal of speech data from a speech transducer at the transmitter, a modulator for converting the AF signal into an RF signal, a transmitting unit including a PTT-key for initiating the transmission of the RF signal, a source of additional data for transmission from the transmitter to the receiver with the speech data, a connection unit at the transmitter between the speech transducer and the transmitting unit for combining the speech data with the additional data, a suppressor for suppressing a predetermined portion of an AF speech spectrum of the AF signal at the transmitter, means for embedding the additional data in the suppressed portion of the AF speech spectrum for the transmission thereof with the speech data in response to the activation of the PTT-key, a demodulator at the receiver for demodulating the received RF signal, and means for using the demodulated signal at the receiver.

20. Apparatus according to claim 19 wherein the connection unit includes a frequency barrier operatively coupled with the PTT-key and operable for eliminating the predetermined portion of the AF speech spectrum in response to the activation of the PTT-key.

21. Apparatus according to claim 19 wherein the receiver includes a receiving unit for the RF signals and a speech transducer, and including a band pass filter between the receiving unit and the speech transducer for removing the additional data from the portion of the AF speech spectrum of the signal.

22. Apparatus according to claim 21 wherein the receiving unit includes a frequency barrier for removing a carrier signal for the additional data contained in the portion of the AF speech spectrum.

23. Apparatus according to claim 19 including a timer at the transmitter for adjusting the duration over which the additional data can be embedded in the suppressed portion of the sent RF signal to a predetermined time interval.

24. Apparatus according to claim 23 wherein the predetermined time interval is about 1 second.

25. Apparatus according to claim 19 wherein the sender includes a timer for establishing a minimum duration for sending the RF signal following the activation of the PTT-key.

26. Apparatus according to claim 19 wherein the receiver is mounted in an airplane and includes a data storage holding data identifying the airplane and operatively coupled to the connection unit, the data storage including an ICAO 24-bit code for the airplane, and wherein the receiver is at a ground station and includes a data store assigned to the connection unit and containing at least one of an identifying code for the ground station and airplane guidance information.

27. Apparatus according to claim 19 wherein the suppressor suppresses a frequency band in the range between about 1.5 and 2.5 kHz.

28. Apparatus according to claim 19 wherein the portion of the AF speech spectrum suppressed by the suppressor has a band width between about 200 to 400 Hz.
